(19) United States
(12) Patent Application Publication
(10) Pub. No.: US 2005/0161396 A1
(43) Pub. Date: Jul. 28, 2005

(54) Canning jar strainer

(76) Inventor: Robert Chaput, Garson (CA)

Correspondence Address: Mike Gauthier, Unit C, 959 Elisabella Street, Sudbury, ON, P3A 5K1, CA

(21) Appl. No.: 10/762,266

(22) Filed: Jan. 23, 2004

(51) Int. Cl. B01D 35/02

(52) U.S. Cl. 210/464; 210/470; 210/473

(57) ABSTRACT

A canning jar strainer incorporating both food hold-down means, straining means, and strainer removal means. The present invention comprises: a planar disk-shaped semi-resilient sheet material having a plurality of small incisions located circumferentially around the disk, crescent cutouts and integral pull tabs. Said tabs, when folded toward each other, form a handle, which serve to pull out the strainer and provides distance maintenance between a jar lid and the disk. Therefore, inserting the disk of the present invention into the neck of a conventional canning jar provide means of holding food goods below the liquid line thus preventing oxygenation of said food goods, while also serving as a strainer, which can be easily removed.

### FIELD OF THE INVENTION

The present invention relates to canning jar strainer incorporating both food hold-down means, straining means, and strainer removal means. The present invention comprises: a planar disk-shaped semi-resilient sheet material having a plurality of small incisions located circumferentially around the disk, crescent cutouts and integral pull tabs. Said tabs, when folded toward each other, form a handle, which serve to pull out the strainer and provides distance maintenance between a jar lid and the disk. Therefore, inserting the disk of the present invention into the neck of a conventional canning jar provide means of holding food goods below the liquid line thus preventing oxygenation of said food goods, while also serving as a strainer, which can be easily removed.

### BACKGROUND OF THE INVENTION

Canning foods such as fruits and vegetables has been a food preservation practice for some many years. However, sealing canned contents is of utmost importance to maintaining the quality of said food. Jar manufacturers have long since solved this matter with cool-snap lids. Yet a further problem occurred especially with food items that are buoyant. These buoyant foods, become exposed above the fluid level, and become oxygenated from the small volume of air between said fluid and the lid. To prevent this, a further common practice was introduced wherein a user pours a thin layer of liquid wax onto the food and liquid contents prior to closure of the lids. This of course solves the oxidization problem, but create another, in that, to access the jar's contents, the user must break through said wax covering thus introducing wax pieces within the food content . . . a less than desirable solution.

The inventor sought to provide the canning industry with an inexpensive solution that would overcome all of the above issues by means of creating a semi-resilient disk having straining means, hold-down means and a handle for easy removal thereof.

The applicant is aware of attempts in prior art to provide means of straining jarred food goods within a canning jar.

Of these attempts, many have obtained industrial design patents, which cannot claim function rights over the present invention. Some examples include design Pat. Nos.: D421,555, D459,952, D467,472, and D 479,956.

A utility example of prior art may be had when referring to U.S. Pat. No. 6,418,568 of Briggs et al., issued Jul. 16, 2002 depicting a stopper-strainer device having a diaphragm and a closure plate. The diaphragm is provided with apertures for passage of fluid. The diaphragm is movable between 2 first and second conditions in which the stopper-strainer device functions as a stopper and a strainer, respectively. In the first condition, the closure plate seals with the diaphragm so that the stopper-strainer device functions as a stopper to prevent fluid flow. In the second condition, the closure plate is spaced from the diaphragm and fluid is able to pass through the apertures so that the stopper-strainer device functions as a strainer to allow fluid flow while restraining material entrained in the fluid that is unable to pass through the apertures. However plausible this device may be as a floor drain for instance, it does fail in providing the many specific jarring applications of the present invention. Furthermore, the utility of the device of the present invention needs no closure implement to its strainer function.

### SUMMARY OF THE INVENTION

It is thus the object of the present invention to provide the canning industry with an inexpensive semi-resilient disk having straining means, hold-down means and a handle for easy removal thereof.

In one aspect of the invention, the planar disk-shaped canning strainer may be stamped from sheet material.

In another aspect of the invention, the planar disk-shaped canning strainer may be molded using a high-pressure mould.

In another aspect of the invention, the circumferential edge of the canning strainer may be feathered so as to further enhance its perimeter flexibility thus better conforming to a plurality of conventional canning jars.

Accordingly, the system of the present invention therefore provides an inexpensive semi-resilient disk having straining means, hold-down means and a handle for easy removal thereof.

### BRIEF DESCRIPTION OF THE DRAWINGS

These and other advantages of the invention will become apparent upon reading the following brief description and upon referring to the drawings in which:

FIG. 1 is a perspective view from above of an example of conventional canning jars for use with the present invention. This Figure is for illustrative purposes only and does not form part of the present claimed invention.

FIG. 2 is a partial side elevation view of the state of canned food absent of the use of straining means as shown in a neck-less canning jar.

FIG. 3 is a partial side elevation view of the state of canned food using the strainer of the present invention as shown in a neck-less canning jar.

FIG. 4 is a perspective view from above of the canning jar strainer of the present invention in a collapsed state.

FIG. 5 is a top plan view of the canning jar strainer of the present invention in a collapsed state.

FIG. 6 is a side elevation view of the canning jar strainer of the present invention.

FIG. 7 is a perspective view from above of the canning jar strainer of the present invention showing the handle portion in an erect state and a spoon placed in the alternate crescent pull-out.

FIG. 8 is a top plan view of the canning jar strainer of the present invention showing the handle portion in an erect state.

FIG. 9 is a side elevation view of the canning jar strainer of the present invention showing the handle portion in an erect state.

FIG. 10 is a partial side elevation view the state of canned food absent of the use of straining means as shown in a necked canning jar.

FIG. 11 is a partial side elevation view of the state of canned food using the strainer of the present invention as shown in a necked canning jar.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

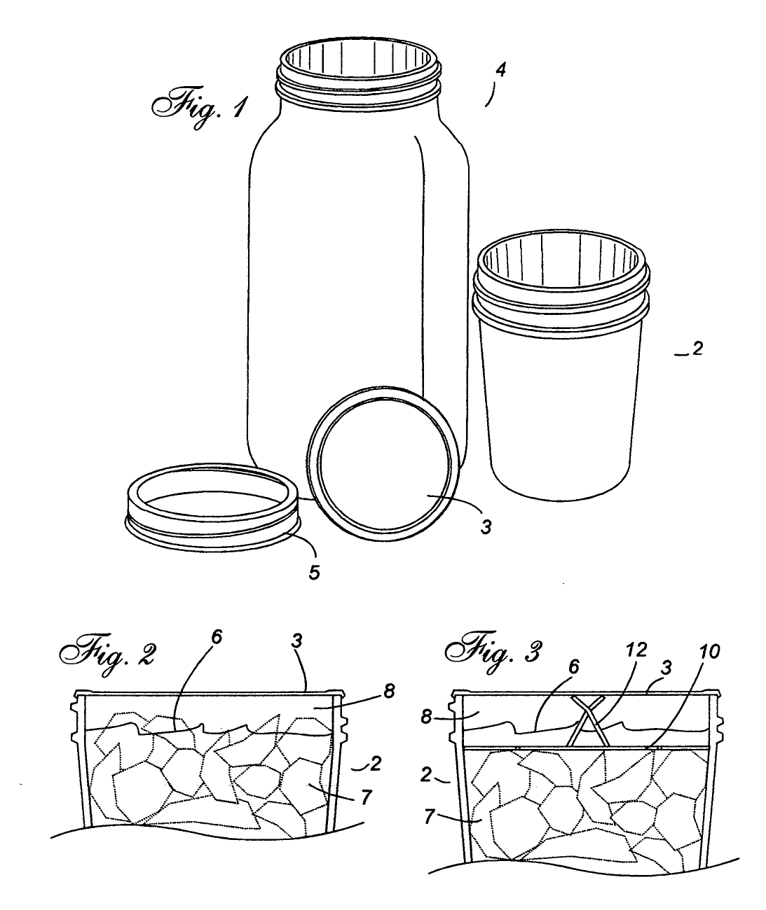

Turning to the drawings, in particular, FIG. 1, which illustrates a perspective view from above conventional canning jars for use with the present invention. Typically, canning jars include two types: neck-less 2 and necked 4 jars, both utilizing a cold snap closure 3 and a threaded retainer ring 5. When heated food goods are placed within these jars, and a cold snap closure 3 retained atop, the cooling of said food goods creates a vacuum seal within said jars 2 and 4.

Turning now to FIG. 2, a partial side elevation view of the state of canned food absent of the use of straining means as shown in a neck-less canning jar wherein, foods 7 that are buoyant will undoubtedly float above the fluid level 6 thus exposing said foods 7 to a trapped volume of highly oxygenated air 8. The result is that of food discoloration and possible spoilage.

FIG. 3, a partial side elevation view of the state of canned food using the strainer of the present invention as shown in a neck-less canning jar illustrating more particularly, the canning jar strainer 10 having its integral pull tabs 12 joined together, forming a generally X-shape thereby providing both a handle, and a hold-down implement wherein said integral handle provides sufficient space between the cold snap closure 3 and the food goods 7 thereby allowing fluids to upwardly traverse the strainer 10 to a level above the food goods 7 thus preventing the food goods 7 from air contact within said jar.

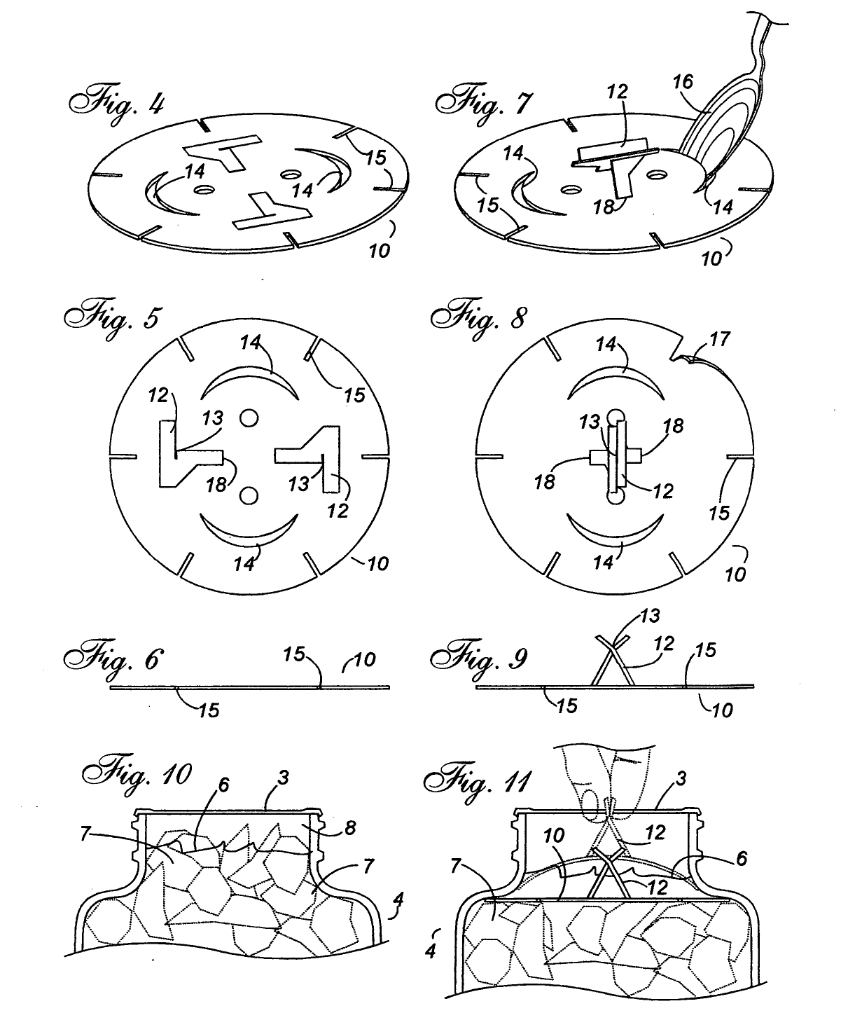

Turning now to FIGS. 4, 5 and 6, all various views of the canning jar strainer 10 of the present invention wherein said canning jar strainer 10 comprises: a planar disk-shaped semi-resilient sheet material having a plurality of small incisions 15 located circumferentially around the disk 10, crescent cut-outs 14 and integral pull tabs 12. Said tabs 12, when folded toward each other, form a handle, which serve to pull out the strainer and provides distance maintenance between a jar lid 3 and the disk 10 thus preventing the food goods 7 from air exposure within the uppermost portion of the sealed canning jar.

In reference now to FIGS. 7, 8 and 9, also various views of the canning jar strainer 10 of the present invention further illustrating the arrangement of the integral pull tabs 12 wherein said pull tabs 12 are partially cut out of the canning jar strainer 10 with the exception of a narrow edge 18 forming a hinge at which the pull tabs 12 pivotally and integrally engage to the disk 10. One or more crescent shaped voids 14 are removed from the disk 10 thereby providing a profile generally similar to that which a conventional cutlery spoon 16 would require to penetrate said disk 10 thereby allowing an alternate means of removing said disk 10 from a canning jar.

Referring now to FIG. 8, a top plan view of the canning jar strainer 10 of the present invention showing the handle portion 12 in an erect state wherein the two tabs 12 are formed to include a slot 13 at the intersection of the central and outer portions thereof. Said tabs 12 can then be interlocked to form an X arrangement as better seen in FIG. 9.

FIG. 10, illustrates a partial side elevation view the state of canned food absent of the use of straining means as shown in a necked canning jar thus enabling the very same problem as described in FIG. 2.

Referring now to FIG. 11, a partial side elevation view of the state of canned food 7 using the strainer 10 of the present invention as shown in a necked canning jar 4 wherein, in this type of canning jar 4, the flexible sheet material of the strainer 10 of the present invention may be distorted enough to be pressed below the neck line of a necked canning jar 4 while holding down the food goods below the fluid level 6. The buoyant food goods 7 would therefore apply a small upward pressure to the underside of the strainer 10, and the strainer would thereby rest under the canning jar's neck. However, the strainer 10 is firm enough to accept the slight upward pressure but resilient enough to distort its shape while being pulled outward from the pull tabs 12 when so desired. Furthermore, the plurality of slots 15 help enable this flexing to ease the removal of the disk.

The canning jar strainer of the present invention can be washed, sterilized and reused many times over.

1. A canning jar strainer comprising a planar disk-shaped sheet material having:
i. a plurality of incisions located circumferentially around the disk,
ii. one or more crescent cutouts,
iii. integral pull tabs.

2. The canning jar strainer of claim 1 wherein the firmness in material is greater than the upward pressure exerted by buoyant foods afloat in the can fluid.

3. The canning jar strainer of claims 1 and 2 wherein the crescent cutouts are shaped to generally fit the profile of a conventional utensil spoon.

4. The crescent cutout of the canning jar strainer of claim 3 wherein said cutout serves both for straining and for lifting said disk out from a canning jar.

5. The canning jar strainer of claims 1 to 4 wherein the utility thereof is to prevent buoyant foods from exposure to trapped air within a canning jar.
